(19) United States
(12) Patent Application Publication
(10) Pub. No.: US 2009/0098924 A1
(43) Pub. Date: Apr. 16, 2009

(54) Gaming machine and playing method thereof

(76) Inventor: Yukinori Inamura, Tokyo (JP)

Correspondence Address: ARENT FOX LLP, 1050 CONNECTICUT AVENUE, N.W., SUITE 400, WASHINGTON, DC, 20036, US

(21) Appl. No.: 11/976,312

(22) Filed: Oct. 23, 2007

(30) Foreign Application Priority Data
Oct. 24, 2006 (JP) 2006-288415

(51) Int. Cl. A63F 9/24; A63F 13/00

(52) U.S. Cl. 463/20

(57) ABSTRACT

The rearrangement symbol data is received from a host computer 200 that determines symbols in a rearrangement in a base probability state in which a probability that the symbols 180 rearranged will constitute a specific relation is a predetermined probability and determines symbols in a rearrangement in a high probability state in which a probability that the symbols 180 rearranged will constitute a specific relation is higher than the predetermined probability, when a predetermined condition is realized. Based on rearrangement symbol data, the symbols 180 are rearranged. A win is determined by a relation of the symbols 180 rearranged.

### CROSS-REFERENCE TO RELATED APPLICATIONS

This application is based on and claims the benefit of priority from the prior Japanese Patent Application No. 2006-288415 filed on Oct. 24, 2006.

### BACKGROUND OF THE INVENTION

1. Field of the Invention

The invention relates to a gaming machine and a playing method thereof.

2. Description of Related Art

In a conventional gaming machine, when a player inserts a game medium such as coin or bill into an insertion slot of the gaming machine and pushes a spin button, symbols are scroll-displayed in a display mounted on a front of a cabinet and the symbols are then stopped automatically.

In such gaming machine, as disclosed in U.S. Pat. No. 6,604,999 B2 or U.S. Patent No. 2002065124A1, for example, when the symbols stopped on a winning line constitute a predetermined combination, the predetermined number of game media are paid out as a win. In addition, when a certain symbol referred to as scatter symbol is displayed on the display, the predetermined number of game media are paid out in accordance with the number of scatter symbols displayed, irrespective of the winning line.

### SUMMARY OF THE INVENTION

In the conventional gaming machines, the considerations about an effect have been made. For example, a win is generated in accordance with a predetermined combination of symbols stopped on a payline or a win is generated in accordance with the number of scatter symbols stopped, irrespective of the payline. However, a chance of awarding the win is typically designed so that the chance is randomly generated in a predetermined probability. Even with the design, a software or electric control circuit has not been positively designed so as to implement the continuous generation of the win. In other words, the win is typically designed so that it is randomly generated.

An object of the invention is to provide a gaming machine having an entertainment characteristic, which is not provided in the prior art, and a playing method thereof.

In addition, another object of the invention is to provide a gaming machine having a new entertainment characteristic, in which a winning form, which is not provided in the prior art, is provided, i.e., a concentration of the winning is implemented, and a playing method thereof.

A gaming machine of the invention comprises a display that arranges a plurality of symbols; a communication device that is connected to a host computer in a data communication manner, the host computer determining symbols in a rearrangement in a base probability state in which a probability that the symbols rearranged will constitute a specific relation is a predetermined probability and determining symbols in a rearrangement in a high probability state in which a probability that the symbols rearranged will constitute a specific relation is higher than the predetermined probability, when a predetermined condition is realized; and a controller that rearranges the symbols based on rearrangement symbol data about the symbols in a rearrangement and determines a win by a relation of the symbols rearranged, the rearrangement symbol data being received to the communication device from the host computer.

According to the above structure, when a predetermined condition is realized, since the symbols in a rearrangement, which are determined by a host computer, are apt to constitute a specific relation, a win may be continuously generated which is determined by the symbols that are rearranged in the specific relation. Therefore, a winning form, which is not provided to the prior art, may be realized.

In addition, a gaming machine of the invention comprises a display that arranges a plurality of symbols arranged in a predetermined order; and a controller programmed to operate as described in (a) to (c). Specifically, the controller is programmed: (a) to rearrange the symbols every unit game, (b) to change the arrangement of the symbols so that the symbols rearranged are apt to constitute a specific relation, when a predetermined condition is realized, and (c) to determine a win by a relation of the symbols rearranged.

According to the above structure, when a predetermined condition is realized, an arrangement of the symbols is changed, so that the symbols rearranged are apt to constitute a specific relation. Accordingly, a win may be continuously generated which is determined by the symbols that are rearranged in the specific relation. As a result, a winning form, which is not provided to the prior art, may be realized.

According to the invention, there is provided a playing method of a gaming machine using a display that arranges a plurality of symbols, which method comprises the steps of: rearranging the symbols based on rearrangement symbol data about the symbols in a rearrangement, the rearrangement symbol data being received from a host computer, and the host computer determining symbols in a rearrangement in a base probability state in which a probability that the symbols rearranged will constitute a specific relation is a predetermined probability and determining symbols in a rearrangement in a high probability state in which a probability that the symbols rearranged will constitute a specific relation is higher than the predetermined probability, when a predetermined condition is realized; and determining a win by a relation of the symbols rearranged.

According to the above structure, when a predetermined condition is realized, since the symbols in a rearrangement, which are determined by a host computer, are apt to constitute a specific relation, a win may be continuously generated which is determined by the symbols that are rearranged in the specific relation. Therefore, a winning form, which is not provided to the prior art, may be realized.

In addition, according to the invention, there is provided a playing method of a gaming machine using a display that arranges a plurality of symbols arranged in a predetermined order, which method comprises the steps of: (a) rearranging the symbols every unit game; (b) changing the arrangement of the symbols so that the symbols rearranged are apt to constitute a specific relation, when a predetermined condition is realized, and (c) determining a win by a relation of the symbols rearranged.

According to the above structure, when a predetermined condition is realized, an arrangement of the symbols is changed, so that the symbols rearranged are apt to constitute a specific relation. Accordingly, a win may be continuously generated which is determined by the symbols that are rearranged in the specific relation. As a result, a winning form, which is not provided to the prior art, may be realized.

According to the above structures, a gaming machine having an entertainment characteristic, which is not provided in the prior art, and a playing method thereof are provided.

### BRIEF DESCRIPTION OF THE DRAWINGS

Other and further objects, features and advantages of the invention will appear more fully from the following description taken in connection with the accompanying drawings, in which:

FIG. 1 illustrates a playing method of a gaming machine;

FIG. 2 is a block diagram of a gaming machine;

FIG. 3 illustrates a display screen;

FIG. 4 shows symbols and code numbers thereof;

FIG. 5 shows symbols and code numbers thereof;

FIG. 6 illustrates a relation of gaming machines and a host computer;

FIG. 7 is a perspective view showing an external appearance of a gaming machine;

FIG. 8 is a block diagram showing a control circuit of a gaming machine;

FIG. 9 is a block diagram showing a control circuit of a host computer;

FIG. 10 is a flow chart of a signal receiving process;

FIG. 11 is a flow chart of a game executing process;

FIG. 12 is a flow chart of a bonus game process;

FIG. 13 is a flow chart of a combination determining process;

FIG. 14 illustrates a playing method of a gaming machine; and

FIG. 15 is a block diagram of a gaming machine;

### DESCRIPTION OF THE PREFERRED EMBODIMENTS

### Embodiment 1

It will be described an embodiment 1 of a gaming machine and a playing method thereof according to the invention.

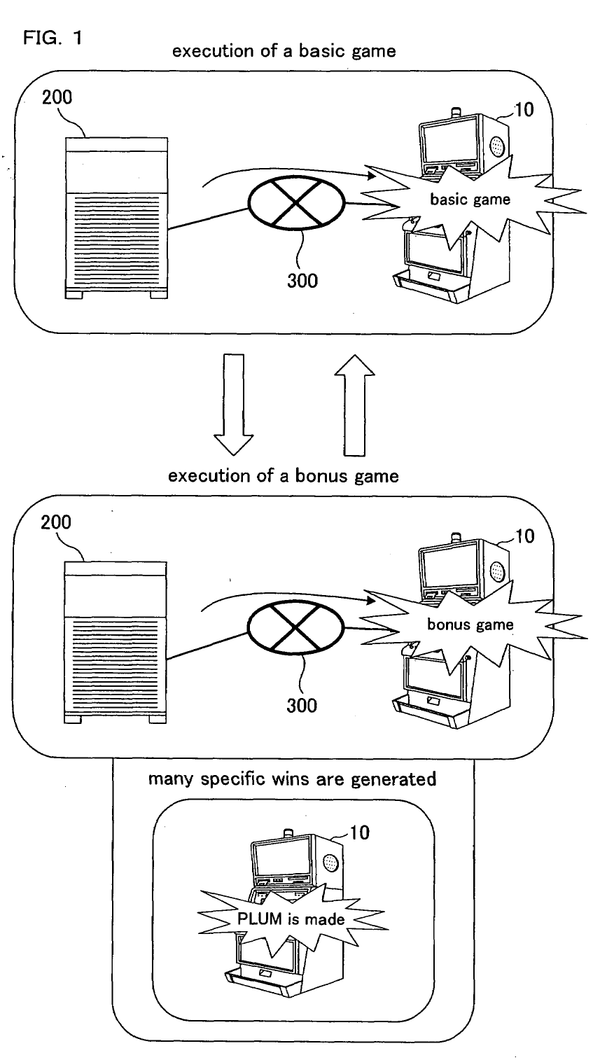

As shown in FIG. 1, a gaming machine executes a playing method comprising the steps of rearranging a plurality of symbols based on rearrangement symbol data about the symbols in a rearrangement, the rearrangement symbol data being received from a host computer 200, and the host computer 200 determining symbols in a rearrangement in a base probability state in which a probability that the symbols rearranged will constitute a specific relation is a predetermined probability and determining symbols in a rearrangement in a high probability state in which a probability that the symbols rearranged will constitute a specific relation is higher than the predetermined probability, when a predetermined condition is realized; and determining a win by a relation of the symbols rearranged.

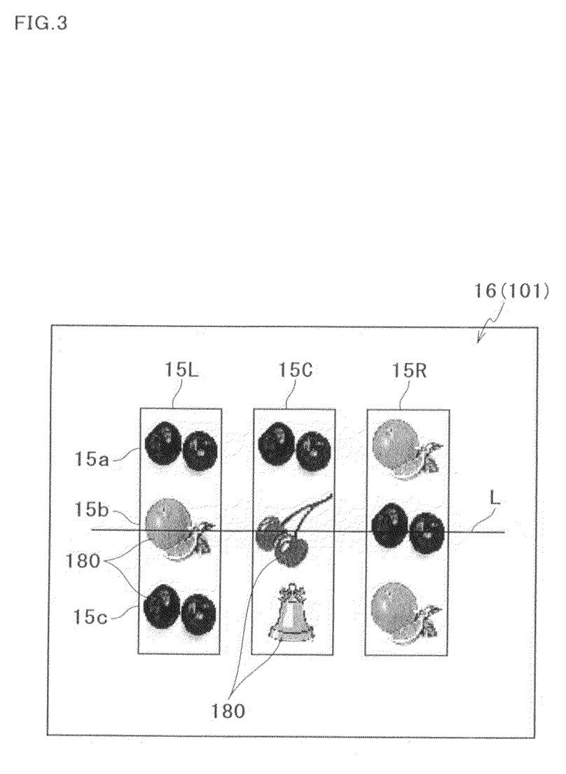

Herein, the “arrangement” means a state in which the symbols 180 are allowed to be visible with naked eyes of an exterior player. In other words, in FIG. 3, the symbols 180 are under state of being displayed in the display windows 15L, 15C, 15R. In the mean time, the “rearrangement” means arranging the symbols 180 again after dismissing the arrangement of the symbols 180.

In addition, the “predetermined condition” means a bonus game in this embodiment. Furthermore, the “specific relation” means that the symbols 180 of 3 (three) “PLUM” are arranged on a payline L shown in FIG. 3. In other words, a bonus game has a probability that the symbols 180 of 3 (three) “PLUM” will be arranged on a payline L, which is higher than in a basic game in which a probability that the symbols 180 of 3 (three) “PLUM” will be arranged on the payline L is a predetermined probability.

(Display Unit 101)

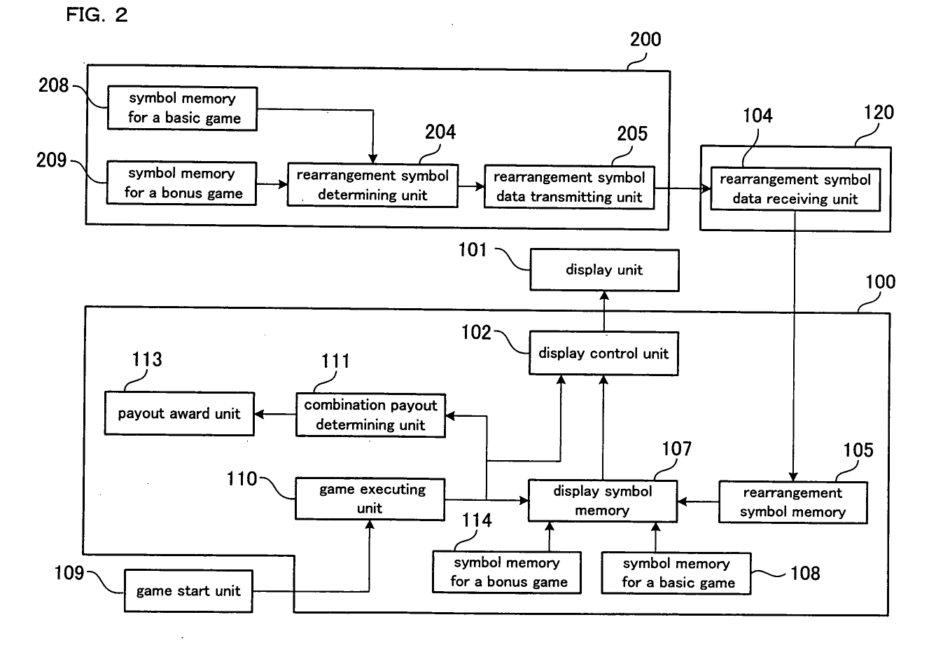

As shown in FIG. 2, the gaming machine executing the above playing method is provided with a display unit 101 (display), a communication device 120 and a controller 100. The display unit 101 is configured to arrange the symbols 180.

The display unit 101 may be a mechanical structure with a reel device for arranging the symbols by rotation of a reel or electrical structure with a video reel on which an image is displayed for arranging the symbols. Further, the display unit 101 may be a structure of combining a mechanical structure (reel) and an electrical structure (video reel). The electrical structure may include a liquid crystal device, a CRT (cathode-ray tube), a plasma display and the like. A detailed structure of the display unit 101 will be described later.

(Communication Unit 120)

The communication device 120 has a rearrangement symbol data receiving unit 104 that receives the rearrangement symbol data about the symbols in a rearrangement from a host computer 200.

(Controller 100)

The controller 100 is structured to execute a first process of rearranging a plurality of symbols based on rearrangement symbol data about the symbols in a rearrangement, which rearrangement symbol data is received from a host computer 200 that determines symbols in a rearrangement in a base probability state in which a probability that the symbols rearranged will constitute a specific relation is a predetermined probability and determines symbols in a rearrangement in a high probability state in which a probability that the symbols rearranged will constitute a specific relation is higher than the predetermined probability, when a predetermined condition is realized; and a second process of determining a win by a relation of the symbols rearranged. In other words, the controller 100 has a first processing unit and a second processing unit.

The controller 100 comprises a symbol memory 108 for a basic game, which stores all symbols in a basic game, a symbol memory 114 for a bonus game, which stores all symbols in a bonus game, and a display symbol memory 107 for storing, as a display symbol, the symbols in the symbol memory 108 for a basic game or the symbol memory 114 for a bonus game. The display symbol memory 107 can be accessed by a display control unit 102. The display control unit 102 reads out the symbol in the display symbol memory 107 under control of a game executing unit 110 and displays the symbols in a display unit 101. A detailed display state will be described later.

In addition, the controller 100 comprises a rearrangement symbol memory 105 that stores rearrangement symbols about the rearrangement symbol data received by the rearrangement symbol data receiving unit 104 of the communication device 120. The rearrangement symbols stored in the rearrangement symbol memory 105 are outputted to the display symbol memory 107, are used for an image process in the display control unit 102 and are thus displayed in the display unit 101. In other words, the controller 100 executes the first process of rearranging the symbols 180 based on the rearrangement symbol data.

Further, the controller 100 is connected to a game start unit 109. The game start unit 109 has a function of outputting a game start signal in accordance with an operation of a player. The controller 100 comprises a game executing unit 110 for executing a unit game in which the symbols 180 are rearranged with a game start signal, as trigger, from the game start unit 109, a combination payout determining unit 111 for determining a payout determined by a combination of the symbols 180 rearranged in a unit game, and a payout award unit 113 for awarding the respective payouts determined in the combination payout determining unit 111. In other words, the controller 100 executes the second process of determining a win by a relation of the symbols 180 rearranged.

In the mean time, each block of the controller 100 may be structured with a hardware or software, as required.

(Host Computer 200)

As shown in FIG. 2, the host computer 200 has a symbol memory 208 for a basic game that stores all symbols in a basic game and a symbol memory 209 for a bonus game that stores all symbols in a bonus game.

In addition, the host computer 200 has a rearrangement symbol determining unit 204 that determines the symbols in a rearrangement, based on the symbols stored in the symbol memory 208 for a basic game or the symbol memory 209 for a bonus game. The symbols in a rearrangement, which are determined by the rearrangement symbol determining unit 204, are transmitted to the communication device 120 from a rearrangement symbol data transmitting unit 205, as the rearrangement symbol data.

(Operation of the Controller 100)

With the above structure, an operation of the controller 100 will be described. Firstly, the rearrangement symbol data about the symbols in a rearrangement determined in the host computer 200 is stored as rearrangement symbols in the rearrangement symbol memory 105 through the rearrangement symbol data receiving unit 104. Meanwhile, the symbols in a rearrangement, which are stored in the rearrangement symbol memory 105, are stored in the display symbol memory 107. The symbols in a rearrangement in the display symbol memory 107 are enabled to be displayed in the display unit 101 by the display control unit 102. When a unit game is executed by a game executing unit 110, the symbols in a rearrangement in the display symbol memory 107 are displayed in the display unit 101, so that the symbols 180 are rearranged. Thereby, the controller 100 executes the first process of rearranging the symbols 180 based on the rearrangement symbol data.

A win is determined by a relation of the symbols rearranged and a payout based on the win is awarded by a combination payout determining unit 111 and a payout award unit 113. Thereby, the controller 100 executes the second process of determining a win by a relation of the symbols 180 rearranged.

As clearly seen from the above operation, the gaming machine 10 implements a playing method comprising the steps of rearranging a plurality of symbols 180 based on rearrangement symbol data about the symbols in a rearrangement, the rearrangement symbol data being received from a host computer 200, and the host computer 200 determining symbols in a rearrangement in a base probability state in which a probability that the symbols 180 rearranged will constitute a specific relation is a predetermined probability and determining symbols in a rearrangement in a high probability state in which a probability that the symbols 180 rearranged will constitute a specific relation is higher than the predetermined probability, when a predetermined condition is realized; and determining a win by a relation of the symbols 180 rearranged.

According to the above playing method, during the bonus game, the symbols of 3 (three) “PLUM” are apt to be arranged on a payline L. Therefore, in a bonus game, a win may be continuously generated which is determined by the symbols 180 of 3 (three) “PLUM” arranged on the payline L.

(Display State)

It will be specifically described an example of a display state of the display unit 101, with respect to the operation processes of the gaming machine 10 and the playing method. In the mean time, as shown in FIG. 3, the display state will be described with reference to a structure in which the display unit 101 arranges the symbols in a video reel manner.

The display unit 101 has display windows 15L, 15C, 15R as an arrangement area for arranging the symbols 180. The display windows 15L, 15C, 15R are arranged in a central part of the display unit 101. In the display windows 15L, 15C, 15R, symbol columns consisting of the symbols 180 are scroll-displayed. In addition, each of the display windows 15L, 15C, 15R is divided into upper, center and lower stages 15a, 15b, 15c. Each of the symbols is stopped (arranged) in the respective stages 15a, 15b, 15c. For example, in FIG. 3, “PLUM” is stopped in the upper stage 15a of the display window 15L, “ORANGE” is stopped in the center stage 15b of the display window 15L and “PLUM” is stopped in the lower stage 15c of the display window 15L. As a result, the display windows 15L, 15C, 15R display a symbol matrix consisting of 3 columns and 3 rows. In the mean time, the symbol matrix is not limited to 3 columns/3 rows.

In addition, a payline L is provided to horizontally traverse the center stages 15b of each of the display windows 15L, 15C, 15R. The payline L is provided to determine a combination of the symbols 180. In other words, when the symbols 180 are arranged on and out of the payline L, a combination is determined only for the symbols 180 rearranged on the payline L. As a determination of the combination, when a winning combination is made, a process of paying out a coin based on the winning combination is carried out, for example.

In the mean time, in this embodiment, the payline L is provided and a process is carried out which pays out a coin when the symbols stopped on the payline L constitute a predetermined combination, for example. However, a process may be carried out which pays out a coin when the predetermined number of symbols referred to as scatter symbol is displayed in the display unit 101, irrespective of the payline L.

(Symbol, Combination and the Like)

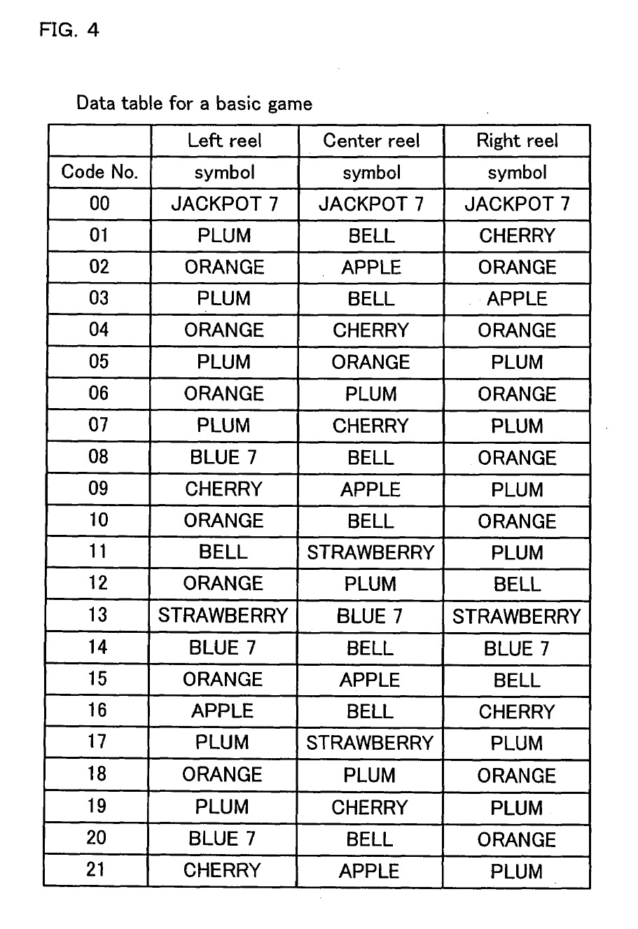

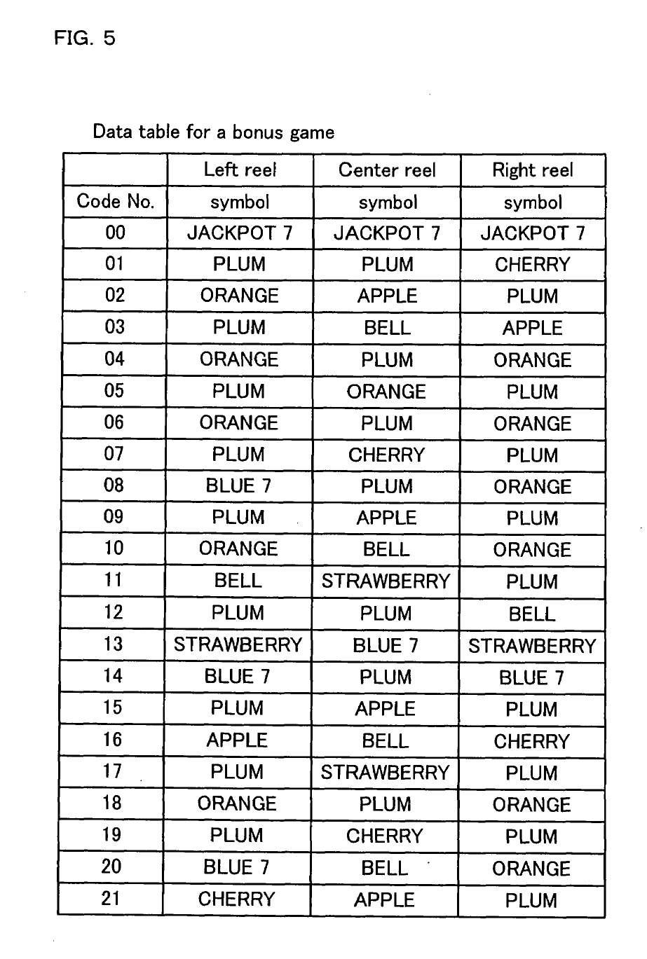

The symbols 180, which are displayed in the display windows 15L, 15C, 15R of the display unit 101, constitute symbols columns by 22 symbols, as shown in FIGS. 4 and 5. The symbols constituting the respective columns of symbols are given with one code number of 0˜21. Each of the symbol columns is constituted with a combination of symbols of “JACKPOT 7,” “BLUE 7,” “BELL,” “CHERRY,” “STRAWBERRY,” “PLUM,” “ORANGE” and “APPLE.”

The three successive symbols in the symbol columns are displayed (arranged) in the upper, center and lower stages 15a, 15b, 15c of the respective display windows 15L, 15C, 15R, so that they constitute a symbol matrix of 3 columns/3 rows. When a 1-BET button 26 or MAX-BET button 27 is pushed and then a spin button 23 is pushed, the symbols constituting the symbol matrix start the scroll. When the scroll starts, the scrolls of the respective symbols are stopped (rearranged) after a predetermined time period has elapsed.

In addition, various winning combinations are predetermined with regard to the respective symbols. The winning combination is a combination that a combination of symbols stopped on the payline L becomes an advantageous state to the player. The advantageous state is a state in which a coin is paid out in accordance with the winning combination, the payout-number of coins is added to the credit, a bonus game is started, and the like.

Specifically, when a combination of “APPLE” symbol is stopped on the payline L, a bonus is triggered and a gaming state is shifted to a bonus game from a basic game. In addition, when a symbol of “CHERRY” is stopped on the payline L, 20 coins (game medium) are paid out per one bet. When a symbol of “PLUM” is stopped on the payline L, 5 coins are paid out per one bet.

In the mean time, a bonus game is a gaming state that is more advantageous than a basic game. In this embodiment, the bonus game is a game having a high probability that the symbols 180 of 3 (three) “PLUM” will be arranged on the payline L. In the mean time, another bonus game may be added as long as it is a gaming state advantageous to the player, i.e., it is more advantageous than the basic game. For example, the bonus game may include a state in which it is possible to obtain more game media than the basic game, a state in which it is possible to obtain a game medium in a higher probability than in the basic game, a state in which the game media are less consumed than in the basic game, and the like. To be more specific, another bonus game may include a free game allowing a player to play a game for a predetermined number of times, without betting a coin.

The symbol columns shown in FIG. 4 are displayed in the display windows 15L, 15C, 15R in a basic game. In the mean time, the symbol columns shown in FIG. 5 are displayed in the display windows 15L, 15C, 15R in a bonus game. The symbol columns shown in FIG. 5 have more “PLUM” symbols than the symbol columns shown in FIG. 4. For example, in the symbol columns shown in FIG. 4, a symbol of a left reel, which has a code No. 09, is “CHERRY”. However, in the symbol columns shown in FIG. 5, a symbol of a left reel, which has a code No. 09, is “PLUM.”

Thereby, when the host computer 200 determines, as the symbols in a rearrangement, a symbol of a left reel as a symbol of code No. 05, a symbol of a center reel as a symbol of code No. 18 and a symbol of a right reel as a symbol of code No. 02, respectively, the symbols 180 of “PLUM,” “PLUM” and “ORANGE” are sequentially arranged from left on the payline L in the symbol columns of FIG. 4 in a basic game, so that a win is not made. In the mean time, for the same case, the symbols 180 of “PLUM,” “PLUM” and “PLUM” are arranged in the symbol columns of FIG. 5 in a bonus game, so that a win is made. In other words, the symbol columns shown in FIG. 5 are used, so that a win relating to the symbols 180 of “PLUM” is easily made.

Like this, during the bonus game, since the data table of FIG. 5 is used to determine the symbols in a rearrangement, the symbols 180 of 3 (three) “PLUM” are apt to be arranged on the payline L. Therefore, during the bonus game, since a win, which is determined by the symbols 180 of 3 (three) “PLUM” arranged on the payline L, may be continuously generated, a winning form, which is not provided in the prior art, may be realized.

(Mechanical Structure of the Gaming Machine 10)

In the followings, it will be described an example of the gaming machine structured in a mechanical and electrical manner.

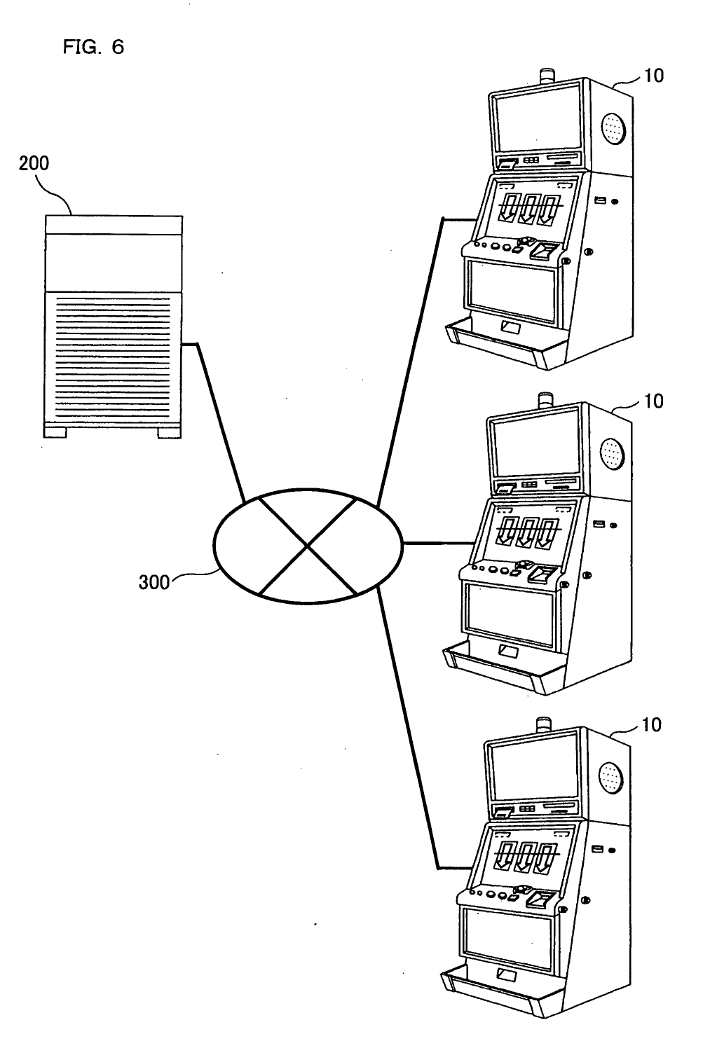

As shown in FIG. 6, a plurality of the gaming machines 10 are provided in a game arcade. Each of the gaming machines 10 is connected to the host computer 200 through an internet communication network 300, in a communication manner.

The gaming machine 10 executes a unit game by using a game medium. The game medium is a coin, bill or electronic negotiable information corresponding to them. Meanwhile, in the invention, the game medium is not particularly limited. For example, a medal, token, electronic money, ticket and the like can be used. The ticket is not particularly limited and may be a barcoded ticket which will be described later.

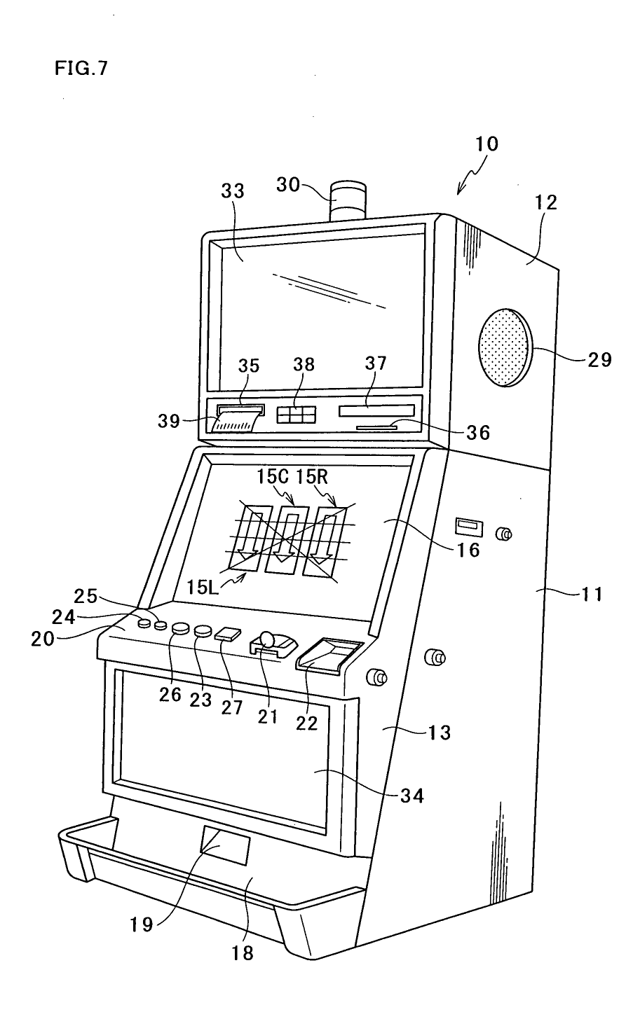

As shown in FIG. 7, the gaming machine 10 comprises a cabinet 11, a top box 12 provided to an upper part of the cabinet 11 and a main door 13 provided to a front of the cabinet 11. A lower image display panel 16 is provided to the main door 13. The lower image display panel 16 has a transparent liquid crystal panel for display the various information. The lower image display panel 16 displays the various information or effect images relating to a game as well as a video reel. Specifically, the lower image display panel 16 displays the display windows 15L, 15C, 15R of 3 columns/3 rows, as shown in FIG. 3, and other effect images, as required.

In addition, in this embodiment, the lower image display panel 16 is used to display the symbols of 3 columns/3 rows. However, the invention is not limited thereto. For example, mechanical reels having the symbols on the outer peripheries thereof may be rotated and stopped, thereby displaying the symbols beyond the display windows 15.

One activated payline L is displayed in the lower image display panel 16. The payline L is set to horizontally traverse the center stages 15b of the display windows 15L, 15C, 15R. In addition, in this embodiment, the payline L horizontally traverses the center states 15b of the display windows 15L, 15C, 15R. However, the payline L may traverse the other stages of the display windows 15L, 15C, 15R. For example, the payline L may traverse the upper stages 15a or lower stages 15c of the display windows 15L, 15C, 15R. In addition, the payline L may traverse the lower stage 15c of the display window 15L, the center stage 15b of the display window 15C and the upper stage 15a of the display window 15R. Further, the payline L may 2 or more. When two or more paylines L are provided, all paylines L may be activated, and the number of paylines L relating to a predetermined condition such as bet-number of coins may be activated.

In the mean time, a credit-number display unit and a payout-number display unit may be displayed in the lower image display panel 16. The credit-number display unit displays a total number that the gaming machine 10 can pay out to a player (which will be referred to as total credit-number). The payout-number display unit displays the number of coins to be paid out when a combination of symbols stopped on the payline L is a winning combination.

A control panel 20, a coin receiving slot 21 and a bill validator 22 are provided below the lower image display panel 16. The control panel 20 is provided with several buttons 23˜27. The buttons 23˜27 allow instructions, which are related to a game progress by a player, to be inputted. The coin receiving slot 21 enables a coin to be received in the cabinet 11.

The control panel 20 is provided with a spin button 23, a change button 24, a cash out button 25, a 1-BET button 26 and a MAX-BET button 27. The spin button 23 is a button for inputting an instruction to start the scroll of the symbols. The change button 24 is a button to be used when a player asks a staff in the game arcade for exchange of money. The cash out button 25 is a button for inputting an instruction to pay out the coins of total credit-number into a coin tray 18.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

The bill validator 22 validates whether bill is normal or not and receives the normal bill into the cabinet 11. In addition, the bill validator 22 can read a barcoded ticket 39 which will be described later. When the bill validator 22 reads the barcoded ticket 39, it outputs a reading signal relating to the read content to a main CPU 41.

A belly glass 34 is provided to a lower frontal surface of the main door 13, i.e., below the control panel 20. A character of the gaming machine 10 and the like are drawn on the belly glass 34. An upper image display panel 33 is mounted to a front of the top box 12. The upper image display panel 33 has a liquid crystal panel and displays, for example, an effect image and an image indicating an introduction of a game content and an explanation of a game rule.

To the top box 12 is mounted a speaker 29 for outputting voice. A ticket printer 35, a card reader 36, a data displayer 37 and a keypad 38 are provided below the upper image display panel 33. The ticket printer 35 prints a barcode having data encoded thereto, such as credit-number, date and time, identification number of the gaming machine 10 and the like, onto a ticket, thereby outputting the barcoded ticket 39. The player can play a game in another gaming machine with the barcoded ticket 39 and exchange the barcoded ticket 39 with bill in a change booth of the game arcade.

The card reader 36 reads and writes the data from and into a smart card. The smart card is a card carried by a player, into which data for identifying the player and data relating to a game history of the player are memorized.

The data displayer 37 consists of a fluorescent display and the like, and displays the data read by the card reader 36 and the data inputted by the player through the keypad 38. The keypad 38 inputs instructions or data relating to a ticket issue.

(Electrical Structure of the Gaming Machine 10)

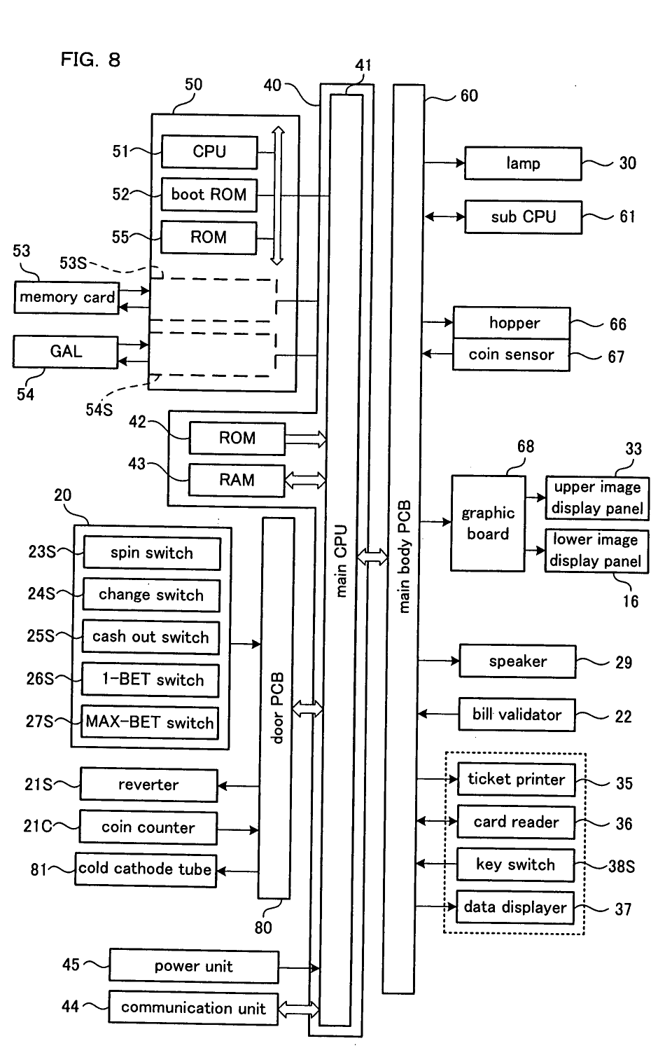

A control unit having the controller 100 shown in FIG. 2 is mounted in the cabinet 11. As shown in FIG. 8, the control unit comprises a motherboard 40, a main body PCB (Printed Circuit Board) 60, a gaming board 50, a sub CPU 61, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol matrix including the three symbols 180 to be stopped on the payline L, based on the rearrangement symbol data about symbols in a rearrangement, which are determined by the host computer 200.

In the mean time, when the gaming machine 10 itself determines the symbols in a rearrangement, the stop symbol determining program may include symbol weight data corresponding to each of several payout rate (for example, 80%, 84%, 88%). The symbol weight data is data representing a correspondence relation between the code number of each symbol and 1 or random numbers belonging to a predetermined numerical range (0˜256) for each of the display windows 15L, 15C, 15R.

The payout rate is determined on the basis of data for setting a payout rate, which data is outputted from the GAL 54, and a stop symbol is determined on the basis of the symbol weight data corresponding to the payout rate when the gaming machine 10 itself determines the symbols in a rearrangement.

Further, the memory card 53 stores various data used for the game program and the game system program. Specifically, the data representing a relation between the symbols 180 to be displayed in the display windows 15L, 15C, 15R of FIG. 1 and the code numbers is stored in a data table form shown in FIGS. 4 and 5. In the mean time, these data are transmitted to a RAM 43 of the motherboard 40 when executing the game program.

In addition, the card slot 53S is structured to insert and remove the memory card 53 and connected to the motherboard 40 through an IDE bus. Accordingly, it is possible to change a type or content of a game to be executed in the gaming machine, by removing the memory card 53 from the card slot 53S, writing another game program and game system program in the memory card 53 and inserting the memory card 53 into the card slot 53S.

The game program includes a program relating to a game progress and a program for shifting a gaming state into a bonus game. The game program also includes image data and sound data outputted during a game.

The GAL 54 is provided with several input and output ports. When the data is inputted into the input ports, the GAL 54 outputs data corresponding to the inputted data from the output ports. When the gaming machine 10 itself determines the symbols in a rearrangement, the data outputted from the output port may be data for setting a payout rate.

The IC socket 54S is structured to attach and detach the GAL 54. The IC socket 54S is connected to the motherboard 40 through a PCI bus. Accordingly, it is possible to change the data for setting a payout rate which is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication unit 44.

The main CPU 41 has functions of a controller for controlling the whole gaming machine 10. In particular, the main CPU 41 carries out a control for outputting a command signal enabling the sub CPU 61 to rotate the symbols of the lower image display panel 16 when the spin button 23 is pushed after the credit is bet, a control for determining symbols to be stopped after the symbols are scrolled and a control for stopping the determined symbols in the display windows 15L, 15C, 15R.

In other words, the main CPU 41 has functions of an arrangement controller for determining a symbol matrix corresponding to the rearrangement symbol data with regard to the symbols in a rearrangement that are determined by the host computer 200 so as to rearrange the symbols, as a new symbol matrix after scrolling the symbols to be displayed in the lower image display panel 16, and executing an arrangement control which will be stopped at the determined symbol matrix from the scroll state.

In addition, the main CPU 41 has a function of the controller 100 that executes the first process of rearranging the symbols 180 based on the rearrangement symbol data about the symbols in a rearrangement, which data is received from the host computer 200, and the second process of determining a win by a relation of the symbols 180 rearranged.

The ROM 42 stores a program such as BIOS (Basis Input/Output System) executed by the main CPU 41, and data that is permanently used. When the BIOS is executed by the main CPU 41, each of peripheral devices is initialized and the game program and the game system program stored in the memory card 53 are read out through the gaming board 50.

The RAM 43 stores the data or program such as rearrangement symbol data, which is used when the main CPU 41 carries out a process. For example, in the RAM 43, the symbol memory 108 for a basic game, the symbol memory 114 for a bonus game, the display symbol memory 107 and the rearrangement symbol memory 105 shown in FIG. 2 are provided in a data area form. The data area of the symbol memory 108 for a basic game stores the symbols 180 in the data table form shown in FIG. 4. The data area of the symbol memory 114 for a bonus game stores the symbols 180 in the data table form shown in FIG. 5. The data area of the rearrangement symbol memory 105 stores the symbols in a rearrangement (three symbols on the payline L). The data area of the display symbol memory 107 stores the symbol matrix including the symbols in a rearrangement.

A communication unit 44 is provided to communicate with the host computer 200 and the like through the internet communication network 300, which are mounted at the inside or outside of the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are connected to a device or apparatus for producing an input signal that will be inputted to the main CPU 41, and a device or apparatus that is controlled by the control signal outputted from the main CPU 41. The main CPU 41 executes the game program and the game system program stored in the RAM 43, based on the input signal inputted to the main CPU 41 to carry out an arithmetic process, thereby storing a result thereof in the RAM 43 or transmitting a control signal to each device or apparatus to control it.

The main body PCB 60 is connected with a lamp 30, the sub CPU 61, a hopper 66, a coin sensor 67, a graphic board 68, the speaker 29, the bill validator 22, the ticket printer 35, the card reader 36, a key switch 38S and the data displayer 37.

The lights-on and out of the lamp 30 is controlled, based on a control signal outputted from the main CPU 41. The sub CPU 61 controls the symbol scroll of the display windows 15L, 15C, 15R and is connected to a VDP (Video Display Processor) 46. The VDP 46 reads out image data of the symbol stored in an image data ROM 47, produces a scroll image to be displayed in the display windows 15L, 15C, 15R and outputs the scroll image in the lower image display panel 16.

The hopper 66 is mounted in the cabinet 11 and pays out predetermined number of coins to the coin tray 18 from the coin payout slot 19, based on the control signal outputted from the main CPU 41. The coin sensor 67 is mounted in the coin payout slot 19 and outputs an input signal to the main CPU 41 when it detects that the predetermined number of coins are paid out from the coin payout slot 19.

The graphic board 68 controls an image display in the upper image display panel 33 and the lower image display panel 16, based on the control signal outputted from the main CPU 41. In addition, the graphic board 68 is provided with a VDP for producing image data on the basis of the control signal outputted from the main CPU 41, a video RAM for temporarily storing the image data produced by the VDP, and the like.

The bill validator 22 reads an image of the bill and accommodates the normal bill in the cabinet 11. In addition, in accommodating the normal bill, the bill validator 22 outputs an input signal to the main CPU 41, based on an amount of the bill. The main CPU 41 stores a credit-number, which corresponds to the amount of the bill transmitted by the input signal, in the RAM 43.

The ticket printer 35 prints a barcode having data encoded thereto, such as credit-number stored in the RAM 43, date and time, identification number of the gaming machine 10 and the like, on a ticket, based on the control signal outputted from the main CPU 41, thereby outputting the barcoded ticket 39.

The card reader 36 reads the data from the smart card to transmit it to the main CPU 41, and writes the data into the smart card, based on the control signal outputted from the main CPU 41. The key switch 38S is mounted to the keypad 38, and outputs an input signal to the main CPU 41 when the player manipulates the keypad 38. The data displayer 37 displays the data which is read by the card reader 36 or the data which the player inputs through the keypad 38, based on the control signal outputted from the main CPU 41.

The door PCB 80 is connected with the control panel 20, a reverter 21S, a coin counter 21C and a cold cathode tube 81. The control panel 20 is provided with a spin switch 23S corresponding to the spin button 23, a change switch 24S corresponding to the change button 24, a cash out switch 25S corresponding to the cash out button 25, a 1-BET switch 26S corresponding to the 1-BET button 26 and a MAX-BET switch 27S corresponding to the MAX-BET button 27. Each of the switches 23S˜27S outputs an input signal to the main CPU 41 when each of the corresponding buttons 23˜27 is pushed by a player.

The coin counter 21C is mounted in the coin receiving slot 21 and validates whether a coin, which is inserted in the coin receiving slot 21 by the player, is normal or not. A coin except the normal coin is discharged from the coin payout slot 19. In addition, the coin counter 21C outputs an input signal to the main CPU 41 when it detects a normal coin.

The reverter 21S is operated on the basis of the control signal outputted from the main CPU 41 and distributes a coin, which is recognized as a normal coin by the coin counter 21C, to a cash box (not shown) or the hopper 66 mounted in the gaming machine 10. In other words, when the hopper 66 is fully filled with the coins, the normal coin is distributed into the cash box by the reverter 21S. In the mean time, when the hopper 66 is not fully filled with the coins, the normal coin is distributed into the hopper 66. The cold cathode tube 81 functions as a backlight mounted to rear sides of the lower image display panel 16 and the upper image display panel 33 and is turned on, based on the control signal outputted from the main CPU 41.

(Electrical Structure of the Host Computer 200)

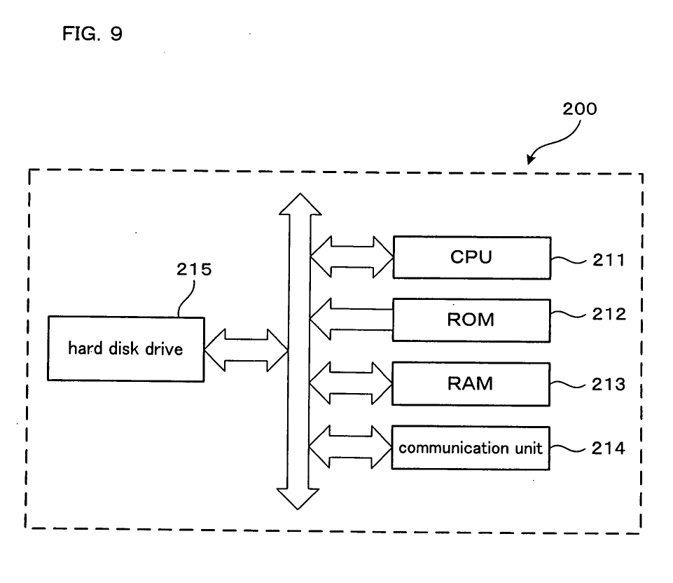

FIG. 9 is a block diagram showing an internal structure of the host computer 200 according to an embodiment of the invention. The host computer 200 comprises a CPU 211 as a processor, a ROM 212, a RAM 213 as a temporary memory device, a communication unit 214 and a hard disk drive 215.

The CPU 211 executes a combination determining process routine, which will be described later, thereby determining the symbols in a rearrangement every unit game for each gaming machine 10. Further, in this embodiment, the host computer 200 is structured to determine only a combination (three symbols) stopped on the payline L as the symbols in a rearrangement. However, the host computer may determine a symbol matrix of 3 columns/3 rows.

The communication unit 214 is connected with the communication unit 44 of each gaming machine 10 communicably through the internet communication network 300. The RAM 213 stores the symbols 180 for a basic game in a data table form shown in FIG. 4 and also stores the symbols 180 for a bonus game in a data table form shown in FIG. 5. In addition, the RAM 213 temporarily stores the data such as rearrangement symbol data to be transmitted to each gaming machine 10. The ROM 212 stores a system program for controlling an operation of a controller or permanent data and the like. The hard disk drive 215 is structured to correspond to each gaming machine 10 and to store the symbols in a rearrangement, which are determined for each gaming machine 10, every unit game.

(Processing Operation of the Gaming Machine 10)

In the followings, the process carried out in the gaming machine 10 will be described. The main CPU 41 reads out and executes a game program, and thereby a game progresses.

(Signal Receiving Process)

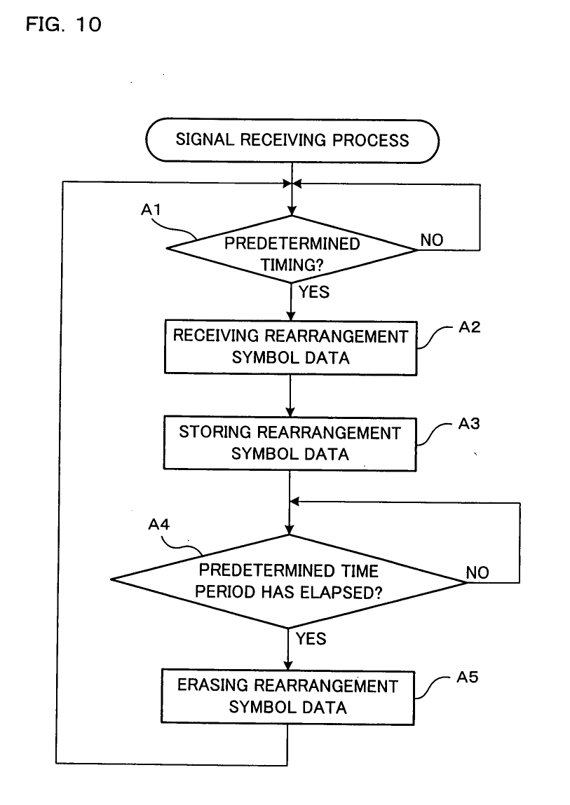

The main CPU 41 of the gaming machine 10 periodically executes a signal receiving process routine shown in FIG. 10. Firstly, it is determined whether or not a predetermined timing (A1). When it is not a predetermined timing (A1, NO), the step of A1 is re-executed and it is under standby state until it is a predetermined timing. When it is a predetermined timing (A1, YES), the rearrangement symbol data is received from the host computer 200 (A2) and is stored in the RAM 43 (A3).

Then, it is determined whether a predetermined time period has elapsed (A4). The predetermined time period is a time period that is necessary for a unit game. When a predetermined time period has not elapsed (A4, NO), the step of A4 is re-executed and it is under standby state until the predetermined time period has elapsed. When a predetermined time period has elapsed (A4, YES), the rearrangement symbol data stored in the RAM 43 is erased (A5) and the process is returned to A1. Thereby, the rearrangement symbol data stored in the RAM 43 is periodically updated, irrespective of whether a game is played in the gaming machine 10.

(Game Executing Process)

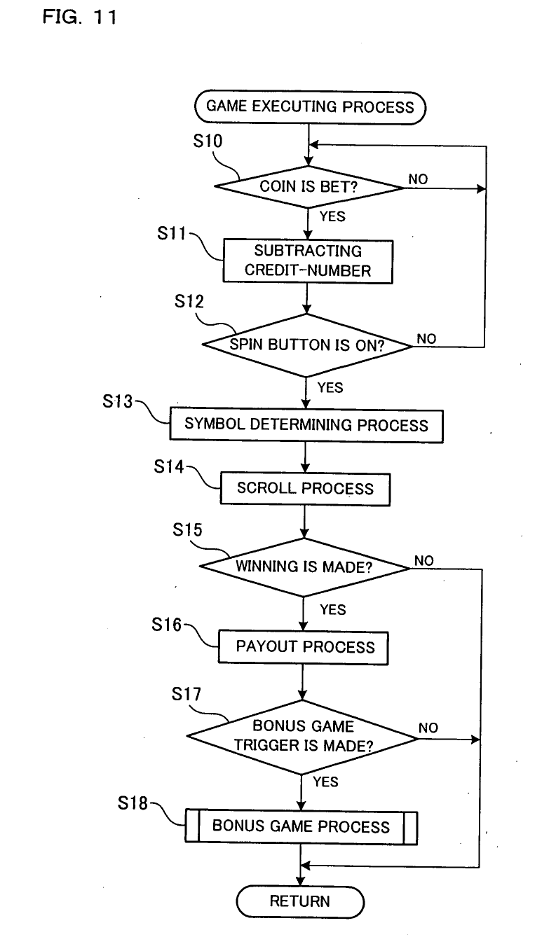

In addition, the main CPU 41 of the gaming machine 10 carries out a game executing process shown in FIG. 11, together with the above signal receiving process routine. First, in the game executing process, it is determined whether a coin is bet (S10). In this process, it is determined whether an input signal is received from the 1-BET switch 26S as the 1-BET button 26 is pushed and whether an input signal is received from the MAX-BET switch 27S as the MAX-BET button 27 is pushed. When the coin is not bet (S10, NO), the step of S10 is re-executed and it is under standby state until a coin is bet.

In the mean time, when the coin is bet (S10, YES), the credit-number stored in the RAM 43 is subtracted, correspondingly to the number of coins bet (S11). Meanwhile, when the number of coins bet is larger than the credit-number stored in the RAM 43, it is not carried out the process of subtracting the credit-number and the step of S11 is re-executed. In addition, when the number of coins bet is above the upper limit (50 pieces in this embodiment) that can be bet per one game, it is not carried out the process of subtracting the credit-number and a step of S12 is carried out.

Then, it is determined whether the spin button 23 is ON or not (S12). When the spin button 23 is not ON (S12, NO), the process is returned to the step of S10. Meanwhile, when the spin button is not ON (for example, an instruction to terminate the game is inputted while the spin button 23 is not ON), the subtraction result in the step of S11 is cancelled.

In the mean time, when the spin button 23 is ON (S12, YES), a symbol determining process is executed (S13), so that a combination in a rearrangement is determined on the basis of the rearrangement symbol data stored in the RAM 43. In other words, a stop symbol determining program stored in the RAM 43 is executed, so that a symbol matrix including the three symbols 180 to be stopped on the payline L is determined.

Then, the symbols 180 of the display windows 15L, 15C, 15R are scroll-displayed (S14). After the symbols 180 are scrolled, the combination determined in the step of S13 is stopped (rearranged) on the payline L.

Then, it is determined whether a winning is made, i.e., a combination of the symbols 180 stopped on the payline L is a winning combination (S15). When the combination is not a winning combination (S15, NO), this routine is ended. In the mean time, when the combination is a winning combination (S15, YES), a payout process is carried out (S16). In other words, it is calculated a payout-number of the coins based on a win of the winning combination. When the coins to be paid out are stored, a predetermined number of the credit is added to the credit-number stored in the RAM 43. In the mean time, when the coins are paid out, a control signal is transmitted to the hopper 66, so that a predetermined number of the coins are paid out.

Then, it is determined whether a bonus trigger is made as a winning combination (S17). In other words, it is determined whether a combination of “APPLE” is arranged on the payline L. When it is determined that a bonus trigger is not made (S17, NO), this routine is ended. When it is determined that a bonus trigger is made (S17, YES), a bonus game process is executed (S18). The bonus game process will be specifically described later. Then, this routine is ended.

(Bonus Game Process)

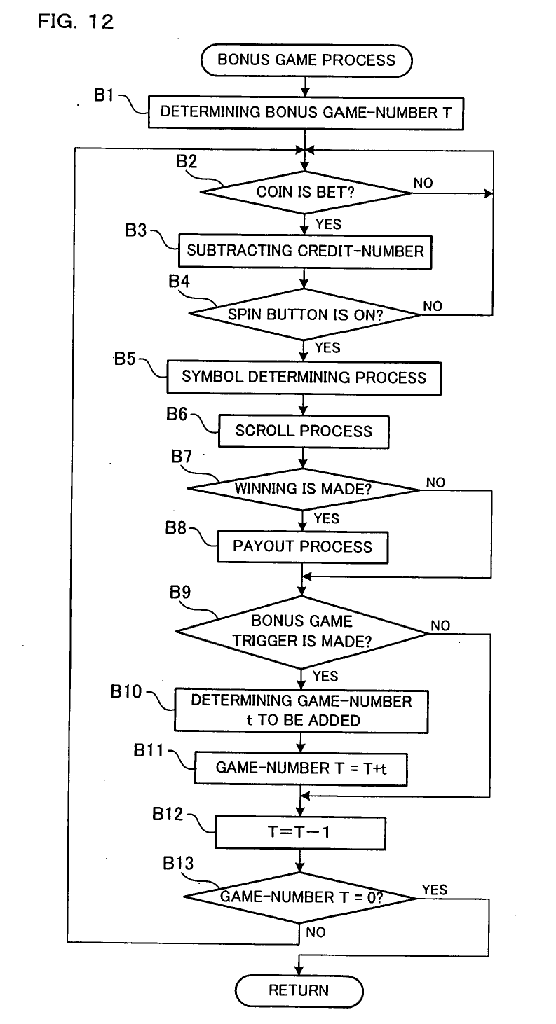

The main CPU 41 of the gaming machine 10 executes a bonus game process routine shown in FIG. 12 when a bonus trigger is made in the step of S17 of FIG. 11. Firstly, a bonus game-number T is determined (B1). Then, it is determined whether a coin is bet (B2). In this process, it is determined whether an input signal is received from the 1-BET switch 26S as the 1-BET button 26 is pushed and whether an input signal is received from the MAX-BET switch 27S as the MAX-BET button 27 is pushed. When a coin is not bet (B2, NO), the step of B2 is re-executed and it is under standby state until a coin is bet.

In the mean time, when a coin is bet (B2, YES), the credit-number stored in the RAM 43 is subtracted depending on the number of coins bet (B3). When the number of coins bet is more than the credit-number stored in the RAM 43, the step of B3 is re-executed without subtracting the credit-number. In addition, when the number of coins bet is above the upper limit (50 pieces in this embodiment) that can be bet per one game, the step of B4 is executed without subtracting the credit-number.

Then, it is determined whether the spin button 23 is ON (B4). When the spin button 23 is not ON (B4, NO), the process is returned to B2. Meanwhile, when the spin button 23 is not ON (for example, an instruction to terminate the game is inputted while the spin button 23 is not ON), the subtraction result in the step of B3 is cancelled.

In the mean time, when the spin button 23 is ON (B4, YES), a symbol determining process is carried out (B5), so that a combination in a rearrangement is determined on the basis of the rearrangement symbol data stored in the RAM 43. In other words, a stop symbol determining program stored in the RAM 43 is executed, so that a symbol matrix including the three symbols 180 to be stopped on the payline L is determined.

Then, the symbols 180 of the display windows 15L, 15C, 15R are scroll-displayed (B6). After the symbols 180 are scrolled, the combination determined in the step of B5 is stopped (rearranged) on the payline L.

Then, it is determined whether a winning is made, i.e., a combination of the symbols 180 stopped on the payline L is a winning combination (B7). When the combination is a winning combination (B7, YES), a payout process is carried out (B8). In other words, it is calculated a payout-number of the coins, based on a win of the winning combination. When the coins to be paid out are stored, a predetermined number of the credit is added to the credit-number stored in the RAM 43. In the mean time, when the coins are paid out, a control signal is transmitted to the hopper 66, so that a predetermined number of the coins are paid out.

Then, it is determined whether a bonus trigger is made as a winning combination (B9), when the combination is not a winning combination (B7, NO) or after the step of B8. In other words, it is determined whether a combination of “APPLE” is arranged on the payline L. When it is determined that a bonus trigger is made (B9, YES), a game-number t to be added is determined (B10). Then, the added game-number t is added to the bonus game-number T (B11).

When it is determined that a bonus trigger is not made in the step of B9 (B9, NO) or after the step of B11, the bonus game-number T is subtracted by “1” (B12). Then, it is determined whether the bonus game-number is “0” or not (B13). When the bonus game-number is not “0” (B13, NO), the process is returned to the step of B2. In the mean time, when the bonus game-number is “0” (B13, YES), this sub routine is ended.

(Processing Operation of the Host Computer 200)

In the followings, a process that is carried out in the host computer 200 will be described.

(Combination Determining Process)

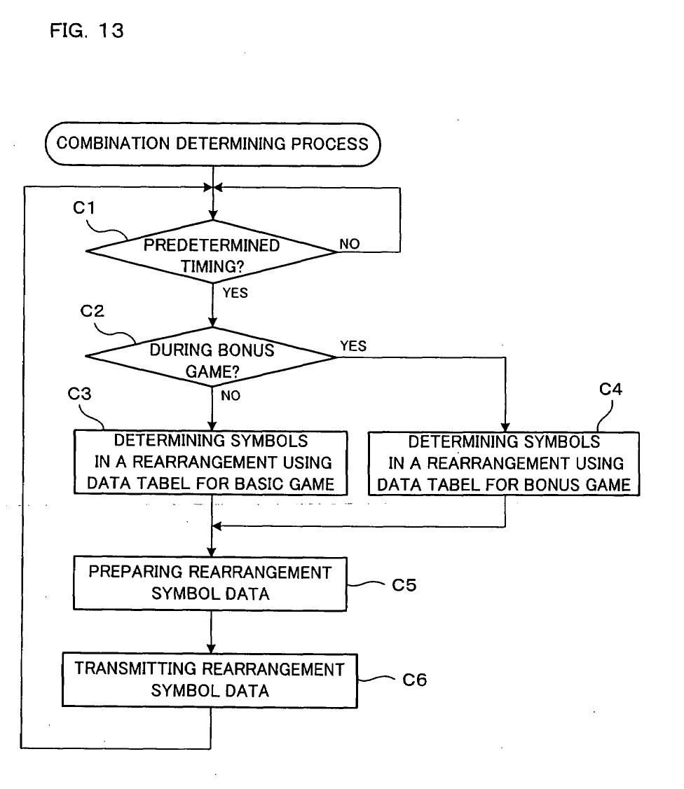

The CPU 211 of the host computer 200 periodically carries out the combination determining process of FIG. 13. Firstly, it is determined whether or not a predetermined timing (C1). When it is not a predetermined timing (C1, NO), the step of C1 is re-executed and it is under standby state until it is a predetermined timing. When it is a predetermined timing (C1, YES), it is determined whether or not a bonus game (C2)

When it is not during a bonus game (C2, NO), the data table for a basic game of FIG. 4 is used to determine the symbols in a rearrangement (C3). Meanwhile, when it is during a bonus game (C2, YES), the data table for a bonus game of FIG. 5 is used to determine the symbols in a rearrangement.

Like this, during a bonus game, the data table for a bonus game of FIG. 5 is used to determine the symbols in a rearrangement. Therefore, the symbols 180 of 3 (three) “PLUM” are apt to be arranged on the payline L. Accordingly, during the bonus game, since a win, which is determined by the symbols 180 of 3 (three) “PLUM” arranged on the payline L, may be continuously generated, a winning form, which is not provided in the prior art, may be realized.

After the step of C3 or C4, the rearrangement symbol data is prepared (C5) and is transmitted to the gaming machine (C6). Then, the process is returned to C1.

### Embodiment 2

In the followings, an embodiment 2 of the gaming machine 10 and the playing method thereof will be described. Meanwhile, the members same as the embodiment 1 are denoted as the same reference numerals and the descriptions thereof are omitted.

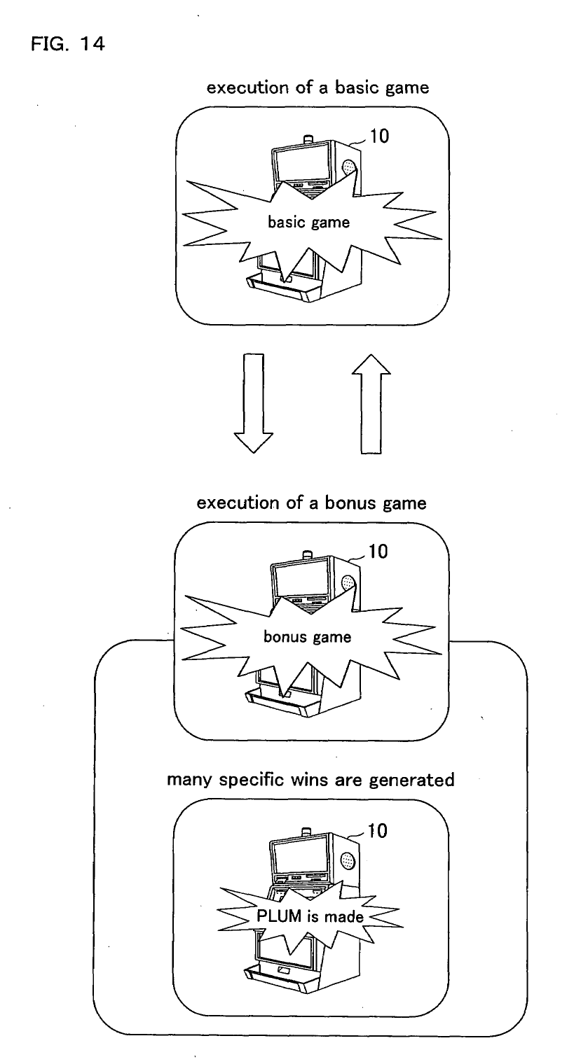

The gaming machine 10 of an embodiment 2 is not connected to the host computer thorough an internet communication network 300 in a communication manner, as the gaming machine 10 of the embodiment 1. Therefore, the symbols in a rearrangement are determined every unit game by each gaming machine 10. In other words, as shown in FIG. 14, the gaming machine 10 executes a playing method comprising the steps of rearranging the symbols 180 arranged in a predetermined order; changing the arrangement of the symbols 180 so that the symbols 180 rearranged are apt to constitute a specific relation, when a predetermined condition is realized; and determining a win by a relation of the symbols 180 rearranged.

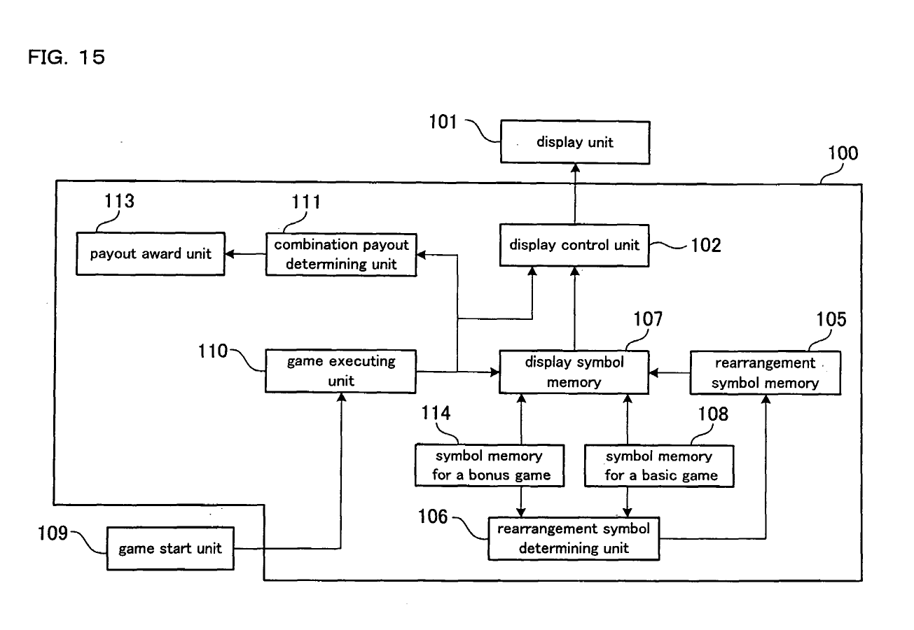

The gaming machine 10 of the embodiment 2 comprises, as shown in FIG. 15, a display unit 101 (display) and a controller 100. In other words, as the embodiment 1, the gaming machine is not provided with the communication device 120 enabling the data to be transmitted and received between the host computer 200 and the gaming machine. The display unit 101 is configured to arrange the symbols 180 that are arranged in a predetermined order.

The controller 100 is structured to execute a first process of rearranging the symbols 180 every unit game; a second process of changing the arrangement of the symbols 180 so that the symbols 180 rearranged are apt to constitute a specific relation, when a predetermined condition is realized; and a third process of determining a win by a relation of the symbols 180 rearranged. In other words, the controller 100 has a first processing unit, a second processing unit and a third processing unit.

The controller 100 has a rearrangement symbol determining unit 106 that determines the symbols in a rearrangement every unit game, based on the symbols stored by the symbol memory 108 for a basic game or symbol memory 114 for a bonus game. The symbols in a rearrangement, which are determined by the rearrangement symbol determining unit 106, are stored in the rearrangement symbol memory 105, are outputted to the display symbol memory 107, are used for an image process in the display control unit 102 and are thus displayed in the display unit 101. In other words, the controller 100 executes the first process of rearranging the symbols 180 every unit game and the second process of changing the arrangement of the symbols 180 so that the symbols 180 rearranged are apt to constitute a specific relation, when a predetermined condition is realized.

Like this, during a bonus game, the data table for a bonus game of FIG. 5 is used to determine the symbols in a rearrangement. Therefore, the symbols 180 of 3 (three) “PLUM” are apt to be arranged on the payline L. Accordingly, during the bonus game, since a win, which is determined by the symbols 180 of 3 (three) “PLUM” arranged on the payline L, may be continuously generated, a winning form, which is not provided in the prior art, may be realized.

In addition, the controller 100 executes the third process of determining a win by a relation of the symbols 180 rearranged through the combination payout determining unit 111 and the payout award unit 113, as the embodiment 1. The other structure, operation, and the like of the embodiment 2 are the same as these of the embodiment 1.

Although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a display that arranges a plurality of symbols;
a communication device that is connected to a host computer in a data communication manner, the host computer determining symbols in a rearrangement in a base probability state in which a probability that the symbols rearranged will constitute a specific relation is a predetermined probability and determining symbols in a rearrangement in a high probability state in which a probability that the symbols rearranged will constitute a specific relation is higher than the predetermined probability, when a predetermined condition is realized; and
a controller that rearranges the symbols based on rearrangement symbol data about the symbols in a rearrangement and determines a win by a relation of the symbols rearranged, the rearrangement symbol data being received to the communication device from the host computer.

2. A gaming machine comprising:
a display that arranges a plurality of symbols arranged in a predetermined order; and
a controller programmed to operate as described in (a) to (c),
wherein the controller is programmed:
(a) to rearrange the symbols every unit game,
(b) to change the arrangement of the symbols so that the symbols rearranged are apt to constitute a specific relation, when a predetermined condition is realized, and
(c) to determine a win by a relation of the symbols rearranged.

3. A playing method of a gaming machine using a display that arranges a plurality of symbols, the method comprising the steps of:
rearranging the symbols based on rearrangement symbol data about the symbols in a rearrangement, the rearrangement symbol data being received from a host computer, and the host computer determining symbols in a rearrangement in a base probability state in which a probability that the symbols rearranged will constitute a specific relation is a predetermined probability and determining symbols in a rearrangement in a high probability state in which a probability that the symbols rearranged will constitute a specific relation is higher than the predetermined probability, when a predetermined condition is realized; and
determining a win by a relation of the symbols rearranged.

4. A playing method of a gaming machine using a display that arranges a plurality of symbols arranged in a predetermined order, the method comprising the steps of:
(a) rearranging the symbols every unit game;
(b) changing the arrangement of the symbols so that the symbols rearranged are apt to constitute a specific relation, when a predetermined condition is realized, and
(c) determining a win by a relation of the symbols rearranged.
